(19) United States
(12) Patent Application Publication
(10) Pub. No.: US 2006/0047098 A1
(43) Pub. Date: Mar. 2, 2006

(54) Recyclable crosslinked polymers with saturated main chain and thermally reversible urethane crosslink points

(75) Inventors: Peter Anna, Piroska Koz 3., H-1223 Budapest (HU); Gyorgy Bertalan, Budapest (HU); Gyorgy Marosi, Budapest (HU); Andrea Szep, Bodony (HU); Gyorgy Banhegyi, Budapest (HU)

Correspondence Address: OBLON, SPIVAK, MCCLELLAND, MAIER & NEUSTADT, P.C., 1940 DUKE STREET, ALEXANDRIA, VA, 22314, US

(73) Assignee: THE FURUKAWA ELECTRIC CO., LTD., Tokyo (JP)

(21) Appl. No.: 10/532,206

(22) PCT Filed: Oct. 22, 2003
(86) PCT No.: PCT/HU03/00084

§ 371 Date: Apr. 22, 2005

(30) Foreign Application Priority Data
Oct. 25, 2002 (HU) P0203632

(51) Int. Cl. C08G 18/00

(52) U.S. Cl. 528/44

(57) ABSTRACT

The invention relates to thermoplastic cross-linked polymer compound with thermally reversible urethane crosslinkages comprising the following essential components a) to d): a) a thermoplastic polymer component with saturated molecular main chain: b) a component containing isocyanate group(s), either attached to the polymer chain or being present in mobile form in the polymer matrix; c) a component containing hydroxyl group(s) either attached to the polymer chain or being present in mobile form in the polymer matrix; d) a catalyst package promoting the reversible formation and thermal dissociation of urethane bonds, characterized in that at least one of the components b) and c) is attached to the polymer chain and at least one of the additives present in the compound is multi-functional, playing a role in more than one, functionally independent processes. The invention further relates to a process for preparing such compounds by: a) preparing a first additive package containing the monomer(s) of one of the components b) and c) to be grafted and the radical source and a processing aid, by mixing the processing aid first with the radical source, then with other component(s), b) preparing a second additive package containing the other urethane forming component not present in the first additive package, the processing aid, the urethane catalysts and, if both the hydroxyl and the isocyanate components are to be grafted, the radical source, such as peroxide, by mixing first the processing aid with the solid components, then with other component(s), c) melting the thermoplastic polymer, d) mixing the first additive package with the molten polymer at a temperature where the grafting reaction is complete within a few minutes, e) mixing the second additive package with the molten polymer obtained in step, d) at a temperature where the urethane formation reaction is complete within a few minutes, f) followed by proper shaping (e.g. extrusion/granulation, injection, etc.) the compound and cooling down.

### TECHNICAL FIELD

The invention relates to saturated backbone polymers of improved heat resistance above their glass transition temperature (in the case of amorphous polymers) and/or above the melting point of their crystalline phase (in the case of semicrystalline polymers), which can be recycled at an elevated temperature by conventional melt processing methods, wherein the heat stability is provided by thermally reversible urethane bonds as crosslink sites dissociating at a temperature above the glass or melting range but below the onset of the thermal degradation of the polymer.

### BACKGROUND OF THE INVENTION

Normally the thermal resistance of thermoplastic materials is limited by their softening, which (in the case of amorphous polymers) occurs above the glass transition temperature (T_{g}) where the mobility of the macromolecules or their large segments increases abruptly. Below that temperature the material behaves as a rigid glass, above the glass transition temperature the material softens gradually (it becomes a viscoelastic “rubbery” material) and at even higher temperatures it becomes a viscous melt. The width of the “rubbery plateau” depends on the average molecular mass. The usefulness of glassy polymers is limited, however, by their rigidity and brittleness. Other materials, as e.g. saturated polyolefins (polyethylene, isotactic and syndiotactic polypropylene, polyisobutylene etc.) exhibit two characteristic transitions: the glass transition (T_{g}) and the melting point (Tₘ) of the crystalline phase (the latter is always higher than the former, usually T_{g}=0.6−0.8*Tₘ). These molecules exhibit enough symmetry and flexibility to develop micro-crystals but a fully crystalline sate cannot develop due to mobility restrictions. These materials exhibit an interesting “leathery” structure between the two transition temperatures, where tiny crystalline particles are connected by less organized (“amorphous”) polymer chains of increased mobility. These semicrystalline materials exhibit superior mechanical properties to pure amorphous polymers as the crystallites act a “physical crosslinks”, so the deformation is limited (provided that the stress is not high enough to destroy the crystallites as e.g. in the case of “stress whitening”). If, however, the temperature approaches the melting point of the crystalline phase (which is broadened, due to the crystallite size distribution) the mobility increases and the mechanical properties (modulus and strength) degrade abruptly (usually even more abruptly than in the case of the glass-rubber transition, where the change is more gradual).

There are certain applications, however, where the products made of semicrystalline materials spend most of their time at temperatures between the glass transition and the melting temperatures but occasionally thermal overloads may happen and in these cases it is required that the material should not melt and flow, but exhibit a certain degree of mechanical resistance. Two typical examples are cable insulation materials (under overloading conditions) and water pipes used in floor heating. This problem can be partially solved by chemical (or radiation) crosslinking of the material (see e.g. K. Kircher: Chemical Reactions in Plastics Processing, Hanser Publishers, Munich, 1987), which may influence the degree of crystallinity, but does not eliminate it (see e.g. I. Chodak: Properties of Crosslinked Polyolefin-Based Materials, Prog. Polym. Sci., 20, 1165-1199 (1995)). Crosslinked semicrystalline materials exhibit a soft rubber-like behavior between the melting point of the crystalline phase and the thermal degradation temperature of the network. The mechanical properties in this temperature range are much inferior to those exhibited between the melting point and the glass transition temperature, but they are sufficient to prevent material flow and even a certain degree of strength remains. The presence of crosslink sites (network formation), however, seriously limits the recycling possibilities of products made of such materials.

Crosslinked polymers can be re-processed only by milling/grinding (sometimes at cryogenic temperature) or by thermo-mechanical degradation (random scission) at elevated temperature (see e.g. JP 11189670). The former method produces organic fillers of limited value at a relatively high price, the latter yields a melt with strongly branched molecules and broad molecular mass distribution, which cannot be processed by itself, only in combination with virgin thermoplastics (see e.g. JP 10230520). The thermo-mechanical degradation at high temperature (see e.g. JP 11100448) involves large energy consumption (thermal and shear degradation) and leads to high defect concentration in the reprocessed material. Thus it is desirable to develop materials, which exhibit improved properties above the melting point of the crystalline phase but can be re-processed by conventional melt technologies.

### STATE OF THE ART

One obvious way of eliminating the drawbacks of permanent crosslinking is to build up (thermally) reversible crosslinks. A relatively early review of this method (R. W. Rees: Cross-linking, reversible, in: Encyclopaedia of Polymer Science and Engineering, ed. H. F. Mark, N. M. Bikales, C. G. Overberger, G. Menges, Wiley Interscience, New York (1986), pp. 395-416) lists the following possibilities:
ionomer formation
amine-salts
reversible Diels-Alder reaction (cyclopentadienes, opening with maleic anhydride)
dimerisation of nitroso groups
reversible esterification
anhydride crosslinking
complex formation
disulfide bridges.

All these crosslink sites undergo more or less reversible dissociation under the effect of heat, or, in some cases, in the presence of certain chemicals (see e.g. U.S. Pat. No. 6,090,862).

Several patent applications have been submitted which are based on reversible esterification reaction between cyclic anhydrides and polyols (e.g. JP 11181200 or U.S. Pat. No. 3,678,016 for styrene based resins, JP 11106578 or JP 07094029 for polyolefin based resins).

JP 10338711 describes a thermally reversible crosslinked system using a hindered amino group-containing compound—combined with acids. All examples of the patent come from acrylic resins.

U.S. Pat. No. 5,654,368 provides elastomer-like or rubber-like, recyclable cross-linked polymers capable of being liquefied and re-molded repeatedly without detracting from the physical properties of the polymers. The polymer comprises meltable cross-linked oligomer units and linkage units through which the oligomer units are linked to construct the main chains of the polymer. The reversible crosslink sites are based on disulfide bonds, which can be disrupted and regenerated in redox reactions. Other crosslink-sites mentioned in the patent include ester bonds, furane-maleic anhydride Diels-Alder adducts, Si—Si bonds, photo-dimerized coumarin and anthracene ring units.

U.S. Pat. No. 4,882,399 describes an epoxy system with thermally reversible crosslinks. It contains disulfide bridges, which can be cleaved in proper solvents and regenerated under mild oxidizing conditions.

U.S. Pat. No. 3,890,253 describes reversible cross-linking imparted to polymers and copolymers, especially of the vinyl, olefinic, and olefinic oxide types by means of recurring dicyclopentadiene linkages. Difunctional dicyclopentadiene compounds can be polymerized directly into homopolymers or polymerized with comonomers to form copolymers. Alternatively, polymers carrying cyclopentadiene substituents can be prepared and the dimerization of the cyclopentadiene groups effected in situ to produce the cross-linkages. The dicyclopentadiene crosslinkages cleave on heating to a sufficient temperature so that the present polymers and copolymers have a thermoplastic character notwithstanding their normal crosslinked network structure.

DE 10046024 describes a wide range of elastomers with thermally reversible crosslink points based (among others) on the following linkages:
acid anhydride group and an alcohol group
carboxyl group and a vinlyether group
alkyl halogenide group and a tertiary amine group
isocyanate group and a phenolic group
azlacton group and a phenolic group
dimerised nitroso groups
interaction between N-containing heterocycles.

The patent defines the elastomer as a polymer, which has a T_{g} below 25° C. (preferably below 10° C.). It can be any natural or synthetic polymer, which has rubber-elastic properties and which can be vulcanised by proper chemicals into a rubbery network. They may include natural rubbers, thermoplastic elastomers or even saturated polyolefins as polyisobutylene, ethylene-propylene-diene rubber or even chloro-sulfonated polyethylene. Most of these polymers contain residual double bonds (unsaturations) to make possible standard vulcanisation by sulphur. According to he patent the functional groups forming the crosslink site can be both located on polymeric components, or one of them can be attached to the polymer, the other can be a low molecular compound, acting as a crosslinker. The patent does not restrict the way of attaching the functional groups to the polymer chains, it can be done by copolymerisation, grafting etc., although in the examples direct addition reactions (as e.g. in the case of maleic anhydride) or addition reactions via mercapto-functionalised monomers (as e.g. mecapto-phenol) to the residual unsaturations are mentioned. Both solution-based and “dry” methods, such as kneading are allowed to perform the reactions, although most examples mention solvent-based methods. In the example of isocyanate+phenol bond e.g. the isoprene rubber is first reacted in xylene solution with mercapto-phenol, then it is precipitated, dried and mixed with diphenylmethane-diisocyanate (MDI) in a kneader. The content of the crosslink-forming functional groups is preferably below 0.1 mol %. Typically the rubbers with thermo-reversible crosslinks begin to flow at 150-170° C., which makes possible melt-recycling.

The thermal reversibility of urethane bonds formed by the reaction of isocyanates and alcohols is also well known and utilised both in the recycling of polyurethanes and especially in developing blocked iscoyanates which react only under the effect of heat, in the presence of properly chosen catalysts (see e.g. Polyurethane Handbook, Ed.: G. Oertel, Hanser Publishers, Munich 1985, pp., 8, 10, 15, 78, 84, 522, 533, 540). The typical “reversion” temperatures for various kinds of urethane bonds are as follows (see the reference quoted above, p. 84):

| | |
|---|---|
| n-alkyl-NH—COO-n-alkyl | ˜250° C. |
| aryl-NH—COO-n-alkyl | ˜200° C. |
| n-alkyl-NH—COO-aryl | ˜180° C. |
| aryl-NH—COO-aryl | ˜120° C. |

Phenol blocked icoyanates have been widely used, but later more advanced blocking agents (such as oximes, caprolactam, maleic acid esters, acetyl-acetone derivatives or other CH-acids) were developed to prevent the formation of toxic phenolic compounds during the de-blocking reaction, or macromolecular phenols (such as coumarone-indene resins etc.) were used, which do not produce volatile reaction products on deblocking. The deblocking reaction of blocked isocyanates is performed in the presence of a large amount of alcohol groups, and is catalysed by catalysts commonly known to catalyse trans-esterification and/or urethane formation. These include teritary amines, Lewis-acids (especially tin compounds, such as tin-(II) salts of carboxylic acids, dialkyl tin salts of carboxylic acids, Bi, Pb, Zn, Zr salts of medium and long chain fatty acids, various metal-acetylacetonates see e.g. Polyurethane Handbook, Ed.: G. Oertel, Hanser Publishers, Munich 1985 and K. Kircher: Chemical Reactions in Plastics Processing, Hanser Publishers, Munich, 1987).

WO0192366 describes a polyurethane system with thermally reversible bonds, based on urethane groups formed between isocyanates and benzylic OH groups.

Thus, from the above elements it seems possible to develop polyolefins and other thermoplastic polymers of saturated molecular main chain by introducing thermally reversible urethane linkages. Taking into account the approximate decomposition temperatures quoted above, the combination of aromatic isocyanates and phenols seems to be optimal for reversible crosslinks to be processed by melt methods if the matrix is polyethylene (melting point 110-135° C.) and a combination of aliphatic isocyanates and phenols for polypropylene based matrices (melting point above 150° C.), although the actual reversion temperatures depend on other factors, as medium polarity, presence and type of catalysts etc. These polymers would exhibit improved heat resistance above the glass transition temperature or above the melting point of the crystalline phase, but could be re-processed by conventional melt-technologies at a temperature above the thermal dissociation temperature of the urethane bond but below the thermal decomposition of the bonds constituting the main chain. Nevertheless there are several problems, which have to be solved, and which are not described in the patents published so far.

These problems are as follows:
the reversible reaction of phenolic and isocyanate groups is to be realised in a dilute, non-polar environment
mobile reagents of medium or high polarity (compounds with phenolic and/or isocyanate groups) should be distributed in a non-polar, high viscosity medium (in melt, as solutions methods should be avoided due to their complexity, higher price and environmental problems) and phase separation during the reaction should be avoided
the phenolic and/or isocyanate functional groups should be attached to the saturated main chain by radical grafting (there are no residual double bonds to allow for thiol addition, as in the case of typical elastomers) without creating thermally irreversible C—C crosslink sites. This requires the judicious choice of peroxide (or other radical source) and the proper selection of the concentration and reactivity of the compounds to be grafted.
a proper catalyst package should be found which is compatible with the non-polar matrix, which is not volatile and which allows for repeated re-formation of urethane linkages after thermal dissociation
the catalyst package and the phenolic components should be possibly selected so as to reduce the number of necessary additive components (it can be achieved by using multi-functional additives).

It is our objective to solve these non-trivial problems and to provide formulations with the above properties as well as processes for their manufacture. The main intended area of application is cable insulation and/or sheathing produced by continuous vulcanisation (CV) methods or cable insulation in oil-filled (OC) cables.

### DETAILED DESCRIPTION OF THE INVENTION

In one aspect the invention provides thermoplastic polymer compounds with thermally reversible urethane linkages comprising
a.) a thermoplastic polymer component (homopolymer, copolymer or polymer mixture) with saturated molecular main chain
b.) an isocyanate group either attached to the polymer chain (by copolymerisation, grafting or by polymer-analog reactions) or being present in mobile form in the polymer matrix
c.) a phenolic (optionally aliphatic, or cycloaliphatic) hydroxyl group either attached to the polymer chain (by copolymerisation, grafting or by polymer-analog reactions) or being present in mobile form in the polymer matrix
d.) a catalyst package which promotes the reversible formation and thermal dissociation of urethane bonds
e.) optionally a processing aid to facilitate the homogeneous distribution of polar active components and/or catalysts in the compound,
   wherein, if the isocyanate group is attached to the main chain, the hydroxyl component exhibits an average functionality of at least 2; if the hydroxyl component is attached to the main chain, the isocyanate component exhibits an average functionality of at least 2, or if both components are attached to the main chain, the functionalized polymer molecules themselves exhibit an average functionality of at least 2, and the urethane bonds formed by the reaction of the isocyanate and hydroxyl groups undergo reversible thermal dissociation at a temperature between the glass transition temperature or melting point of the thermoplastic polymer and the thermal degradation temperature of the thermoplastic polymer.

The polymer matrices used in the invention are saturated backbone vinyl polymers and copolymers (such as ethylene-vinyl acetete /EVA/, etyhlene-acrylic acid /EAA/, ethylene-ethyl acrylatre /EEA/ etc.), preferably polyolefins. Polyolefins include all kinds of polyethylenes (high density, low density, linear, metallocene etc.), polypropylenes and their copolymers (random or block) and blends (including dynamically vulcanized thermoplastic elastomers). Our main concern is to improve the heat resistance of low density polyethylene (LDPE), which is widely used for medium and high voltage cable insulation, where the continuous use temperature is 90° C., but occasionally it can rise to 110° C. or higher (short circuit conditions). This temperature resistance so far could be achieved only by XLPE (crosslinked polyethylene) or by EPDM (ethylene-propylene-diene monomer copolymer) insulations—neither can be recycled by conventional methods. The use of higher melting point HDPE (high density polyethylene) or PP (polypropylene) or PE-PP copolymers instead of LDPE has been prevented by the inferior mechanical (rigidity) or electrical (breakdown) properties of these alternative materials, although recent patents (see e.g. WO0041187) indicate the viability of this route. LDPE grades with thermally reversible crosslink points could be utilized, however, not only in cable insulation, but in several other areas, as heat resistant water tubes, packaging, heat shrinking materials etc.

Formally there are at least three different ways of preparing the reversible urethane 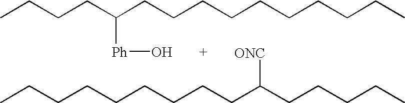
linkages:
a) Coupling both the hydroxyl and isocyanate components to the main chain of the polymer
b) Coupling the isocyanate component to the polymer, and adding the polyol component in mobile (but not volatile) form 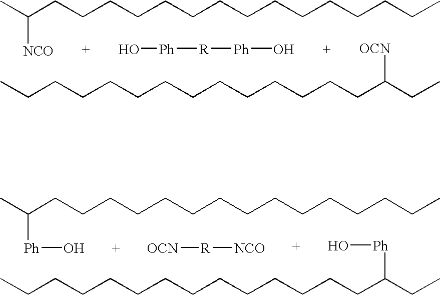
c) Coupling the hydroxyl component to the polymer, and adding the polyisocyanate in mobile (but not volatile) form.

In principle the hydroxyl and/or isocyanate groups can be incorporated into the main chain by copolymerisation (an this possibility is not excluded from the invention) but the preferred way of coupling the reactive groups to the main chain is via radical induced grafting, as this does not require a separate synthetic step and allows the utilisation of existing, commercially available polymer grades. (If the main chain is polypropylene or an etyhlene-propylene copolymer care must be taken to avoid excessive chain scission, which may occur in the presence of peroxides).

The isocyanate component may be grafted to the main chain through a double bond. It can be done by any monomer containing at least one isocyante group and at least one olefinic double bond, e.g. isocyanto-ethyl-acrylate or -methacrylate or isoyanato-propyl-acrylate or methacrylate. If the isocyanate group is grafted onto the main chain, the mobile hydroxyl component can be any polyphenol of low volatility, as e.g. dihydroxy and tirhydroxy benzenes, or any oliogomer or polymer containing phenol groups (novolak resins, other phenol-formaldehyde resins, cumarone-indene resins etc.). The polyphenol can also be a polyvalent phenolic antioxidant or thermal stabilizer commonly used in olefinic resins (such as e.g. Irganox 1010, Santonox R etc.). In this case, however, less strongly hindered phenols should be selected and the formation of urethane bonds should be checked individually. The hindrance of the phenol group may also influence the thermal dissociation temperature of the urethane bond formed and this effect could be utilised to “fine tune” the decomposition temperature of the urethane link. If antioxidants are utilised to form urethane bonds, the reduced concentration of the antioxidant groups should be taken into account when designing the stabiliser package. This approach decreases the number of necessary additive components by using a multi-functional additive.

It is also possible to attach aliphatic alcohol groups to the main chain of the thermoplastic polymer and to react it with a prepolymer containing diisocyanates and polyphenols with a functionality of 2 or higher. In this case the urethane bonds formed in the aliphatic alcohol—isocyanate reaction will dissociate at higher temperature than those formed in the isocyanate—phenol reaction. An example for this last system is to graft hydroxy-ethyl methacrylate to the main chain of the thermoplastic polymer and to react it with an MDI-phloroglucinol prepolymer.

If the (phenolic) hydroxyl component is grafted to the main chain, any phenol containing an olefinic side group may be used, as e.g. allyl-phenol, hydorxy-styrene, vinyl-hydroxy napthalene etc. It is also well known that certain phenolic antioxidants belonging e.g. to the thio-bisphenol class (e.g. Santonox R) can be easily grafted to the polyethylene main chain in the presence of radical initiators (presumably through the broken sulfur bonds). As Santonox R is widely used as antioxidant in cable insulation, its use as a graftable phenolic component (multi-functional additive) again reduces the number of necessary additive components. The reduction of active phenol concentration (by urethane formation) in the antioxidant activity should be take into account, however. Once the phenolic group is attached to the main chain, the crosslinking can be achieved by any di- or polyisocyante monomer or prepolymer commonly used in the polyurethane industry, e.g. toluylene-diisocyanate (TDI), methylene-diphenyl—diisocyanate (MDI), and their dimers, trimers, prepolymers etc. (for a more complete list see: Polyurethane Handbook, Ed.: G. Oertel, Hanser Publishers, Munich 1985 and K. Kircher: Chemical Reactions in Plastics Processing, Hanser Publishers, Munich, 1987). Preferably aromatic diisocyanates with low vapour pressure are used.

Of course both phenolic and isocyanate groups may be grafted onto the main chains using the unsaturated isocyanate or phenol containing molecules mentioned above.

For the realisation of the invention proper reaction partners, (urethane) catalysts, reaction conditions (for grafting, urethane formation and reversion) and processing technologies must be found.

The urethane catalyst package has to be effective, heat stable, non-volatile, compatible with the polymer, and should not affect the final properties of the polymer (e.g. the insulation properties of a cable insulation). It is advisable to use catalysts, which are used not only in polyurethane chemistry, but are also known and proven additives in thermoplastic polymers, as polyolefins. Commonly used urethane catalysts include teritary amines, Lewis-acids (especially tin compounds, such as tin-(II) salts of carboxylic acids, dialkyl tin salts of carboxylic acids, Bi, Pb, Zn, Zr salts of medium and long chain fatty acids, various metal acetyl-acetonates see e.g. Polyurethane Handbook, Ed.: G. Oertel, Hanser Publishers, Munich 1985 and K. Kircher: Chemical Reactions in Plastics Processing, Hanser Publishers, Munich, 1987). Usually a combination of metal salts and tertiary amines is used. One interesting possibility, which is a part of the present invention, is to utilise hindered amine stabilisers (commonly known as HALS stabilisers) as amine catalysts, as the can also play the role of antioxidants and/or voltage stabilisers (radical scavengers) in high voltage cable insulation—thus the number of additives can be reduced by using a multi-functional additive. It is advantageous to use metal salts of long chain fatty acids as co-catalysts, as these compounds are widely applied as lubricants in polyolefins (again a multi-functional additive). It is especially advantageous to use HALS (hindered amine light stabiliser)-Zn-stearate as a catalyst-co-catalyst system.

The grafting conditions should be selected so that the main chain radical (R.) concentration is low enough to avoid recombination (R—R) and the reactivity of the isocyanate and/or hydroxyl group containing molecule should be high enough with the main chain radicals. This can be achieved by the proper selection of the radical generating species (usually peroxide, azo-bis-isobutyro-nitrile, AIBN or other radical initiator) and the reaction temperature. Interactions between the radical generating species and the hydroxyl component to be grafted or the phenolic antioxidants and thermal stabilizers present in the polyolefin matrix should be taken into account to avoid the degradation of stabiliziers.

In another aspect the invention provides a process to prepare the compounds described above consisting of the following steps:
a) preparing a first additive package containing the monomer(s) (which can be the isocyanate component or the hydroxyl component) to be grafted and the radical source (e.g. peroxide) and the (optional) processing aid, by mixing the processing aid first with the radical source, then with other component(s)
b) preparing a second additive package containing the other urethane forming component (if the hydroxyl component is present in the first package, then the isocyanate component, if the isocyanate component is present in the first package, then the hydroxyl component), the processing aid, the urethane catalysts and, if both the hydroxyl and the isocyanate components are grafted, the radical source (e.g. peroxide), by mixing first the processing aid with the solid components, then with other component(s)
c) melting the thermoplastic polymer
d) mixing the first additive package with the molten polymer at a temperature where the grafting reaction is complete within a few minutes
e) mixing the second additive package with the molten polymer at a temperature where the urethane formation reaction, and, if necessary the grafting, is complete within a few minutes
f) after proper shaping (e.g. extrusion/granulation, injection, etc.) the compound is cooled down.

So far the problems of distributing the components in the polymer matrix and the formation of urethane bonds have not been discussed. It is well known that low molecular additives with a polarity different from that of the matrix tend to phase-separate and accumulate at crystal boundaries or in the amorphous phase of polyolefins, which may lead to problems (uneven crosslink distribution, formation of breakdown sites in high voltage insulation, weak spots in oxidative or hydrothermal degradation environment etc.). It is also advisable to graft and distribute the hydroxyl and isocyanate components separately to avoid the agglomeration of urethane groups. These problems can be conveniently solved by adding the components in the form of separate additive packages, which is an important feature of the present invention. If only one of the components are grafted (e.g. the hydroxyl or the isocyanate component), then the grafted component should be combined with the radical source as the first package, and the other component should be combined with the urethane formation catalysts as the second additive package and should be distributed in the polymer subsequently. If both urethane components are grafted the second package should also contain a radical source. If multi-functional additives—either the phenol stabilizer (which may be utilized as a crosslinking agent) or the HALS stabilizer (which may be utilized as an urethane co-catalyst)—are already present in the polyolefin compound to be modified, the preparation of additive package may become simpler.

When distributing minor amounts of low molecular or oligomeric additives in a polymer melt homogeneously, it may be useful to use processing aids, such as high surface area or porous mineral additives, which may absorb the additives in the preparation phase of the additive package and may release them in the processing phase. (This also reduces the probability of explosion if peroxides are used as radical intiators). Examples for such materials include zeolites or other micro-porous silicates and various lamellar silicates, as montmorillonite, bentonite, clay, talc or mica. In order to enhance the compatibility of such minerals with the organic additives they may be rendered organophilic by various surface treatments, such as silane modification etc. It is especially advantageous to use commercially available organophilic bentonites/montmorillonites (e.g. those mentioned in the Examples). If the additives and the processing conditions are properly selected, a partial or complete exfoliation of these organophilic clays may even increase considerably the mechanical, flammability, thermal etc. properties of the matrix resin (nano-composite formation). If one or more components of the additive packages are liquid, pastes can be prepared and conveniently added to the polymer. If none of the components are liquid, solvents may be used to promote the absorption of the components by the processing aid and later this solvent can be removed by distillation or drying.

Preparation of the compounds may be realized in various melt-mixing devices, such as kneaders, mixers, compounding extruders, Buss co-kneader etc., followed by direct shaping or by granulation. It is especially advantageous to utilize multi-port compounding extruders with multiple entries for solid/liquid/paste additives. In this case the separate addition and grafting of various components can be realized in a continuous technology. The granulated product can be later processed by any convenient melt processing technology as compression moulding, injection moulding, extrusion, film blowing etc.

The invention is illustrated by the examples listed below, but they do not limit the scope of the invention. Several alternative possibilities are obvious for those skilled in the art, which are still within the scope and spirit of the invention, limited only by the claims.

### FIGURES

FIG. 1. Arrhenius plot of the viscosity of a paraffin sample crosslinked by 2 phr Perox TB in the presence of TAIC (2 mol TAIC for 3 mol Perox TB). For abbreviations see Table 5.

FIG. 2. Arrhenius plot of the viscosity of a paraffin sample grafted by 0.5 phr Perox TB-HEMA (2 Mol HEMA for 3 mol Perox TB) and crosslinked by TDI-PHL adduct on heating and cooling. For further details see Tables 5 and 6.

FIG. 3. Arrhenius plot of the viscosity of a paraffin sample grafted by 1.0 phr Perox TB-HEMA (2 Mol HEMA for 1 Mol Perox TB) and crosslinked by TDI-PHL adduct on heating and cooling. For further details see Tables 5 and 6.

FIG. 4. Micro-thermal analysis curves of a non-crosslinked PE sample (sample No. 02-33) and three samples with thermally reversible crosslinks, prepared according to Examples 3, 4 and 5 (for sample notation see Table 8.).

FIG. 5. Micro-thermal analysis curves of a non-crosslinked PE sample (sample No. 02-33) and three samples with thermally reversible crosslinks, prepared according to Examples 6, 7 and 8 (for sample notation see Table 11.).

FIG. 6. Micro-thermal analysis curves of a non-crosslinked PE sample (sample No. 02-33) and three samples with thermally reversible crosslinks, prepared according to Examples 9, 10 and 11 (for sample notation see Table 13.).

### BEST MODE TO CARRY OUT THE INVENTION

The reactions used to optimize the polyurethane catalysts (see examples 1. and 2.) were evaluated visually.

The viscosity of the grafted/crosslinked paraffin mixtures used to optimize the reaction conditions and to prove the reversibility of urethane crosslink formation was determined by a standard falling ball viscometer of the Hoppler type, where the temperature is regulated by a circulating bath.

Melt processing experiments (examples 3-11) were performed in a Brabender Plastograph PL 2000 type equipped with an internal mixer chamber (useful volume is 250 cm³). The same equipment was utilized to monitor the re-processability of the crosslinked mixtures.

For detecting the breakdown of the crosslink points in the melt-processed samples the method of Micro-Thermal Analysis (μTA) was also used (TA Instruments, Inc.). This method measures the thermal response, providing information similar to that obtained from conventional thermal analysis. The thermal probe is made from a tiny platinum filament surrounded by a silver sheath. The wire is formed into a probe and the silver is etched away to reveal the platinum tip. A laser beam is reflected by a mirror from the probe to a photodetector. Changes in probe position will generate a change in photodetector voltage. μTA also images the thermal conductivity and thermal diffusivity near to the surface. The probe acts as a resistive heater and provides the means of measuring the temperature. The temperature program applied to the probe can be modulated. In the LTA (localized thermal analysis) experiments the probe heats the sample, and thermal expansion or softening effects can be monitored by detecting the movement of the laser signal on the photodetector. This measurement can be used to determine expansion, softening, melting or glass transition. Changes in the thermal conductivity and thermal diffusivity of the near-surface region also can be measure when the probe is heating. For detection the presence of crosslinks and the thermal dissociation of crosslink the LTA analysis function was applied. A 0.5×5×5 mm size freshly cut flake of the compound was glued onto the table of the device. The thermal probe was heated at a rate of 10° C./s in the temperature range of 30-200° C. after placing the probe on the surface of the sample with a 56 nN loading.

### EXAMPLE 1

Selection of Polyurethane Catalysts and the Proof of Reversible Reaction

For the selection of urethane catalysts and to prove the reversibility of the urethane reaction solution conditions were used, which can be investigated and screened easier than melt-reactions. As a solvent Diphyl (a commercially available heat-transfer medium, a mixture of diphenyl oxide and diphenyl) was used (melting point 12.2° C., boiling point 265° C.), as it has low volatility, dissolves the components and allows reaction kinetic studies in a wide temperature range. For the reaction-kinetic studies TDI (toluylene-diisocyanate) was selected as iocyanate component and thymol as a phenolic component (see Table 1.).

TABLE 1
Properties of the isocyanate and phenol components used
in selecting the urethane catalysts.

| | | | | | Weight | |
|---|---|---|---|---|---|---|
| | | | Mp. | Bp. | loss (TG) | |
| Compound | Formula | Mw. | (° C.) | (° C.). | ° C. | % |
| Toluylene-diisocyanate | C₆H₄(NCO)₂ | 160 | 12-14 | 251 | 80 | 0 |
| (TDI) | | | | | 125 | 5 |
| Aldrich (USA) | | | | | 148 | 10 |
| | | | | | 173 | 20 |
| Thymol (THYM) (Reanal | (CH₃)(C₃H₇)C₆H₃OH | 150 | 51 | 232 | 115 | 0 |
| Fine Chemicals Co. | | | | | 140 | 5 |
| Hungary) | | | | | 150 | 10 |
| | | | | | 160 | 15 |
| | | | | | 170 | 25 |

The catalysts screened are listed below in Table 2:

| | |
|---|---|
| Compound | Appearance, use |

Amine catalysts

| | |
|---|---|
| Pyridine (PYR) | Liquid |
| (Reanal Fine Chemical Co. Hungary) | |
| Chimassorb 944 (ChS944) | Powder |
| (CIBA-GEIGY) | Polymer HALS type stabiliser |
| Chimassorb 119 (ChS119) | Fine granules |
| (CIBA-GEIGY) | Polymer HALS type stabiliser |

Metal salt catalysts

| | |
|---|---|
| Dibutyl tin dilaurate (DBSnDL) | Solution |
| | Trans-esterification catalyst |
| Mg-naphtenate (MgNaph). BUDALAKK- | Paste |
| TITÁN Festékgyártó Kft., Szeged, | Catalyst for coatings |
| Hungary | |
| Mn-octoate (MnOct). BUDALAKK- | Paste |
| TITÁN Festékgyártó Kft., Szeged, | Catalyst for coatings |
| Hungary | |
| Zn-octoate (ZnOct). BUDALAKK-TITÁN | Liquid thick viscous |
| Festékgyártó Kft., Szeged, Hungary | Catalyst for coatings, |
| Zn-stearate (ZnSt) | Powder |
| FACI | Lubricant for thermoplastics |

As one can see, in both categories, we tried to use not only traditional urethane catalysts but also other additives known in thermoplastics (e.g. HALS stabilizers or metal soap lubricants), which are expected to be both effective catalysts and known to be compatible with polyolefin matrices.

The components (relative amounts in weight parts given in Table 3.) were weighed into a stoppered test tube. After intense homogenization of the components, the test tube was capped with a CaCl₂ tube, and immersed in an oil bath of 100° C., until a reaction took place, but maximum. for 60 minutes. The reaction mixture was cooled back to room temperature. Finally the samples were heated again, but this time to 135° C. and kept there for 15 min. The changes in color, viscosity and phase transitions during heating and cooling were observed (see Table 3.).

TABLE 3
Compositions of samples with one kind of catalyst and observations

| | Code of compounds | | | | | |
|---|---|---|---|---|---|---|
| Components | Proportion of components (in weight parts) | | | | | |
| sample No. | F/01/0 | F01/1 | F/01/2 | F/01/3 | F/01/4 | F/01/5 |
| TDI | 1.3 | 1.3 | 1.3 | 1.3 | 1.3 | 1.3 |
| THYM | 2.4 | 2.4 | 2.4 | 2.4 | 2.4 | 2.4 |
| DIPh | 2.9 | 2.9 | 2.9 | 2.9 | 2.9 | 2.9 |
| PYR | 0.08 | | | | | |
| ChS944 | | 0.08 | | | | |
| DBSnDL | | | 0.08 | | | |
| ZnSt | | | | 0.08 | | |
| ZnOct | | | | | 0.08 | |
| MgNaph | | | | | | 0.08 |

Evaluation based on observations

| | | | | | | |
|---|---|---|---|---|---|---|
| At room | Thin | Thin | Thin | Thin | Thin | Thin |
| temp. after | liquid | liquid | liquid | liquid | liquid | liquid |
| preparation | | | | | | |
| At 100° C. | Thin, | Thin, | Solid after | Solid | Solid after | Solid |
| after | viscous | viscous | 5 min. | after 52 min. | 41 min. | after 29 min. |
| heating | after 60 min. | after 60 min. | | | | |
| At room | Thin | Thin | Solid | Solid | Solid | Solid |
| temp. after | liquid | liquid | | | | |
| cooling | | | | | | |
| At 135° C. | Thin | Thin | Thin | Thin | Thin | Thin |
| after | liquid | liquid | liquid | liquid | liquid | liquid |
| heating | | | | | | |
| At room | Thin | Thin | Solid | Solid | Solid | Solid |
| temp. after | liquid | liquid | | | | |
| cooling | | | | | | |

Abbreviations: (for other abbreviations see Tables 1. and 2.)
DIPh = diphyl

The data in the Table 3. prove: a.) the reversibility of urethane formation and b.) that the catalysts (with the exception of dibutyl-Sn(II)-dilaurate) are not effective enough to promote the formation of urethane bonds at 100° C. within a few minutes (typical processing time for polyolefins). Therefore, in a next experiment (see Table 4.) amine type catalysts were combined with metal-based catalysts to see the effect of co-catalysis on the urethane formation.

TABLE 4
Compositions of samples with combined catalysts and observations

| | Code of compounds | | | | | | |
|---|---|---|---|---|---|---|---|
| Components | Proportion of components | | | | | | |
| sample No. | F/01/6 | F/01/7 | F/01/8 | F/01/9 | F/01/10 | F/01/11 | F/01/12 |
| TDI | 1.3 | 1.3 | 1.3 | 1.3 | 1.3 | 1.3 | 1.3 |
| THYM | 2.4 | 2.4 | 2.4 | 2.4 | 2.4 | 2.4 | 2.4 |
| DIPh | 2.9 | 2.9 | 2.9 | 2.9 | 2.9 | 2.9 | 2.9 |
| PYR | 0.08 | 0.08 | 0.08 | | 0.08 | | |
| ChS944 | | | | 0.08 | | 0.08 | |
| ChS119 | | | | | | | 0.08 |
| ZnSt | | | | | 0.08 | 0.08 | 0.08 |
| ZnOct | | | 0.08 | | | | |
| MgNaph | 0.08 | | | 0.08 | | | |
| MnOct | | 0.08 | | | | | |

Evaluation based on observations

| | | | | | | | |
|---|---|---|---|---|---|---|---|
| At room | Thin | Solid | Thin | Solid | Thin | Thin | Thin |
| temp. after | liquid | after | liquid | after | liquid | liquid | liquid |
| preparation | | mixing. | | mixing. | | | |
| At 100° C. | Solid | Solid | Solid | Solid | Solid | Solid | Solid |
| after heating | after 25 min. | | after 6 min. | after | after | after | after 10 min. |
| | | | | 3 min. | 8 min. | 5 min. | |
| At room | Solid | Solid | Solid | Solid | Solid | Solid | Solid |
| temp. after | | | | | | | |
| cooling | | | | | | | |
| At 135° C. | Thin | Thin | Thin | Thin | Thin | Thin | Thin |
| after heating | liquid | liquid | liquid | liquid | liquid | liquid | liquid |
| At room | Solid | Solid | Solid | Solid | Solid | Solid | Solid |
| temp. after | | | | | | | |
| cooling | | | | | | | |

The results clearly show that the combination of catalysts is an effective way to accelerate the urethane formation. It is especially notable that the combination of hindered amine stabilizers and zinc stearate lubricants (both well known additives used in polyolefin processing) yields an effective catalyst/co-catalyst system.

### EXAMPLE 2

Optimization of Grafting/Crosslinking Conditions in a Paraffin Model System. Crosslinking by Grafted Aliphatic Alcohol and Polyphenol-Diisocyanate Preopolymer

Preliminary optimization of crosslinking/grafting conditions was performed in a model system, wherein the polyethylene matrix was replaced by a liquid paraffin (hereinafter abbreviated as PARF, mixture of saturated hydrocarbons, carbon number n<15, Boiling point <350° C.). This low molecular matrix made possible an easy screening of the crosslinking efficiency (liquid/gel) in a dilute non-polar medium.

In this experiment cross-linkage was built up by grafting an unsaturated compound, containing an aliphatic alcohol function (hydroxyethyl methacrylate, HEMA), on the saturated paraffin backbone according to the following reaction
CₙH₂ₙ₊₂+CH₂═C(CH₃)—COO—CH₂—CH₂—OH+Perox→PARF-OH
and by reacting the grafted alcohol with an aromatic polyol—aromatic diisocyanate prepolymer, which can be regarded as a phenol blocked polyisocyanate:
. . . OOC—NH-Ph¹—NH—COO—Ph²—OOC—NH-Ph¹—NH—COO . . .
where Ph¹ is an aromatic group belonging to the diisocyanate and Ph² is another aromatic group belonging to the (phenolic) polyol. (The reagents were chosen so that Ph¹ is substituted with 2 isocyanates and Ph² is substituted with 3 phenolic groups, and the molar ratio of Ph¹ and Ph² is chosen so that the concentrations of the isocyanate and phenolic groups are equal). The crosslinks are formed according to the following schematic reaction
2PARF-OH+ . . . OOC—NH-Ph-NH—COO-Ph²-OOC—NH-Ph¹-NH—COO . . . →PARF-O—CO—NH-Ph¹-NH—COO-Ph²-OOC—NH-Ph¹-NH—CO—O-PARF
where the thermally reversible urethane bonds are those located between the Ph¹ and Ph² groups and a part of the phenolic OH substituents on Ph² are released in the reaction. These bonds can dissociate thermally at temperatures (around 130° C.), where the other urethane bond between the grafted paraffin /PARF-OH/ and the other aromatic isocyanate group remains intact. Rheological measurement (Höppler-viscosimeter) was applied for the detection the degree of crosslinking.

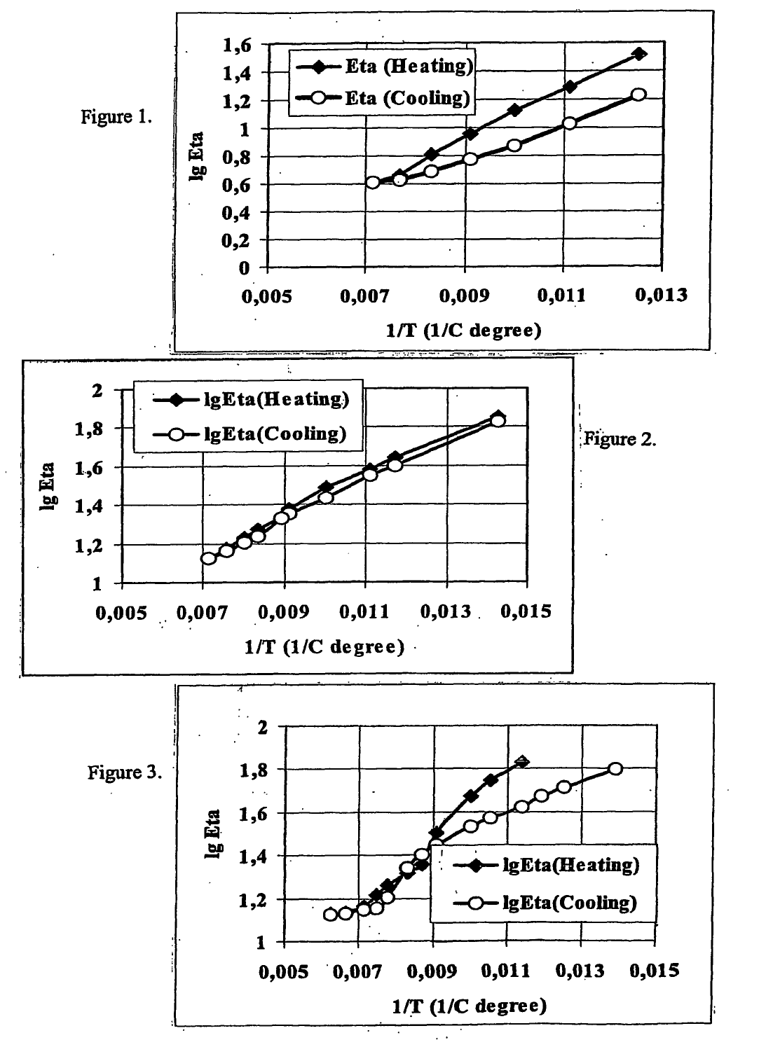

As radical source Luperox F90P (1,3 1,4-bis(terc-butylperoxyisopropyl)benzene, powder on silica surface, conc. 90%, commercially available products of Atofina, France, the active agent hereinafter abbreviated as Perox TB) was used. In preliminary experiments 0.5, 1.0, 2.0, 4.0 and 8.0 phr Perox TB was added to 20 cm³ paraffin and heat-treated at 130° C. for 10 minutes. It turned out that below 2.0 phr peroxide addition the viscosity decreases rather than increases, which indicates that chain scission is more effective than crosslinking. In the 2.0-8.0 phr peroxide range the viscosity increases gradually (by about 50%). To compensate for the chain scission in a next series of experiments the same amounts of peroxide were added to the paraffin but in combination with ⅔ mol triallyl-iscyanurate (a well known trifunctional crosslinking co-agent, commercial product of Degussa AG Germany, hereinafter abbreviated as TAIC, ⅔ mol to each mol of Perox TB) and the crosslinking experiment was repeated. In this case the viscosity increased in the whole concentration range, for e.g. 4 phr Perox TB+TAIC the viscosity tripled in comparison to the non-crosslinked system. The Arrhenius plot (log η−1/T) of the paraffin crosslinked with 4 phr Perox TB and TAIC is shown in FIG. 1. The slope of the curve (proportional to the activation energy of the viscous flow) is fairly constant in the whole temperature range studied, indicating no major change in the mechanism of flow. The system crosslinked with 8 phr Perox TB and TAIC was a gel, so the viscosity could not be measured.

Now we could start to optimise the grafting/crosslinking conditions on the paraffin model using the chemicals shown in Table 5.

TABLE 5
List of the chemicals used to model a reversibly crosslinked system.

| Component | Role of component | Characteristics |
|---|---|---|
| Paraffin oil (PARF) | Matrix | CₙH₂ₙ₊₂ n < 15 |
| | | Bp < 350° C. |
| Luperox F90P | Radical initiator | Powder on Silica surface |
| (Perox TB) | Derivative of terc. butyl | Conc: 90% |
| Atofina | peroxide | |
| Triallyl- | trifunctional | Crystalline solid |
| isocyanurate | crosslinking co-agent | |
| (TAIC), Degussa | | |
| AG | | |
| Phloroglucinol | Aromatic polyol | Crystalline solid |
| (1,3,5-trihydroxy- | | |
| benzene) (PHL) | | |
| 2-Hydroxyethyl- | aliphatic alcohol grafted | Liquid |
| methacrylate | onto PARF to fix the | |
| (HEMA), Aldrich | isocyanate | |
| Zn Stearate (ZnSt) | Urethane formation | See Table 2. |
| | catalyst | |
| Chimassorb 944 | Urethane formation | See Table 2. |
| (ChS944) | catalyst | |
| Toluylene-di- | | See Table 1. |
| isocyanate (TDI) | | |
| Bentone SB | Dispersing agent | Organophilic |
| (RHEOX Inc) | | montmorillonite |

From these HEMA was used to anchor the reversible crosslink site (made of PHL and TDI), Perox TB was used to graft HEMA, ZnSt and ChS944 were the urethane formation catalysts (see Example 1) while Benotne SB played a special role (processing aid). Initial experiments showed that miscibility problems may arise among the various components, which can be largely removed if the various components are absorbed by a small amount of organophilic montmorillonite.

The samples described in Table 6. were prepared according to the following, two-step method: first one phr Bentone was loaded in the test tube, then Peroxide TB and HEMA were weighed to Bentone. The components were intensively homogenised and then gradually diluted with 20 cm³ PARF oil during intensive homogenization. Grafting was performed at 130° C.; in 10 min, without mixing. In a second test-tube one phr Bentone was loaded, then TDI, PHL and the catalysts were loaded, intensively homogenised, and then diluted with the above prepared, grafted and cooled, PARF oil applying intensive homogenisation. The urethane formation was performed by heat treatment at 130° C., in 10 min, without mixing.

TABLE 6
Samples prepared for optimizing thermo-reversible crosslinking

| | Relative amounts of components | | | | |
|---|---|---|---|---|---|
| Perox-TB | 0.5 phr | 1.0 phr | 2.0 phr | 4.0 phr | 8.0 phr |
| (to 100 wt | | | | | |
| PARFF) | | | | | |

| | |
|---|---|
| PARF | 20 cm³ (100 wt) |
| TAIC | 2 Mol to 3 Mol Perox-TB |
| HEMA | 2 Mol to 1 Mol Perox-TB |
| TDI | 2 Mol to 1 Mol Perox-TB |
| PHL | 2 Mol to 3 Mol TDI |
| ZnSt | 6 wt to 100 wt TDI |
| ChS944 | 6 wt to 100 wt TDI |
| Bentone | 2 phr (to 100 wt PARF) |

The breakage of the thermo-reversible urethane bonds was detected indirectly, by monitoring the changes in sample viscosity on heating and cooling. Structural changes were indicated by a relatively sudden change in the activation energy of viscous flow. FIG. 2. shows the Arrhenius plot of viscosity for the sample prepared with 0.5 phr Perox TB and other additives, while FIG. 3. shows similar results for the sample prepared with 2 phr Perox TB. Obviously, the 0.5 phr sample does not show any sign of alteration in the flow mechanism (and activation energy), while the 2 phr sample exhibits sudden changes in the activation energy of viscous flow both on heating and on cooling—indicative of the thermo-reversible crosslinking.

### EXAMPLES 3-5

LDPE Based Compounds with Thermally Reversible Urethane Crosslinks. Crosslinking by Grafted Aliphatic Alcohol and Polyphenol-TDI Prepolymer

Compounds according to the invention were prepared by a two-step grafting/crosslinking procedure. The materials used are described in Table 7, the compositions are listed in Table 8.

TABLE 7
Materials used for preparing examples 3-5.

| | Role of | |
|---|---|---|
| Component | component | Characteristics |
| Tipolen FB 243-51 | Matrix | LDPE |
| (TVK Rt., Hungary) | | Mp. 111° C. |
| | | Density. 0.924 g/cm3 |
| | | MFI:: 0.8 (190° C./2.16 kg) |
| | | (g/10 min) |
| Luperox F90P (Perox TB: | Radical | See Table 5. |
| 1,3-1,4-bis(tert- | initiator | |
| butylperoxyisopropyl)- | Derivative of | |
| benzene on silica powder) | terc. Butyl | |
| (ATOFINA, France) | peroxide | |
| 2-Hydroxyethyl- | Aliphatic | See Table 5. |
| methacrylate (HEMA), | alcohol with | |
| Aldrich | unsaturation | |
| Phloroglucinol | Aromatic | See Table 5. |
| (PHL) | polyol | |
| Toluylene-2,4-diisocyanate | Aromatic | See Table 1. |
| (TDI) | diisocyanate | |
| (Aldrich) | | |
| CHIMASORB 944 (ChS944) | Urethane | See Table 2. |
| (CIBA-GEIGY) | formation | |
| | catalyst | |
| Zinc-stearate | Urethane | See Table 2. |
| (ZuSt) | formation | |
| | catalyst | |
| Bentone SB | Dispersing | See Table 5. |
| (RHEOX Inc.) | agent | |

TABLE 8
The composition of compounds (examples 3-5).

| | | Example 3 | | Example 4 | | Example 5 | |
|---|---|---|---|---|---|---|---|
| sample code | | 02-35a | | 02-36a | | 02-37a | |
| Component | ratio | mol | g | mol | g | mol | g |
| Tipolen FB 243-51 (matrix) | | | 230 | | 230 | | 230 |
| | First additive package | | | | | | |
| Perox-TB* | 0.5-1.5 phr | 0.0034 | 1.15 | 0.0068 | 2.3 | 0.0102 | 3.45 |
| 2-Hydroxy-ethyl- | 2 mol HEMA/ | 0.0068 | 0.88 | 0.0136 | 1.77 | 0.0204 | 2.65 |
| methacrylate (HEMA) | 1 mol Perox-TB | | | | | | |
| Bentone | 1 phr | | 2.3 | | 2.3 | | 2.3 |
| | Second additive package | | | | | | |
| Toluylene-2,4-diisocyanate | 2 mol TDI/1 mol | 0.0068 | 1.18 | 0.0136 | 2.37 | 0.0204 | 3.55 |
| (TDI) | Perox-TB | | | | | | |
| Phloroglucinol (PHL) | 2 mol PHL/ | 0.0045 | 0.57 | 0.0091 | 1.14 | 0.0136 | 1.71 |
| | 3 mol TDI | | | | | | |
| Zinc-stearate (ZnSt) | 6% to TDI | | 0.07 | | 0.14 | | 0.21 |
| Chimasorb 944 (ChS944) | 6% to TDI | | 0.07 | | 0.14 | | 0.21 |
| Bentone | 1 phr | | 2.3 | | 2.3 | | 2.3 |

*Perox TB is given as active ingredient content (90% of the total weight)

The ingredients of the samples were homogenized in a Brabender PL 2000 type laboratory internal-mixer (kneader), equipped with a chamber of 250 cm³ useful capacity. The mixing parameters are listed in Table 9:

TABLE 9
Processing parameters in the Brabender kneader

| | | |
|---|---|---|
| Rotation of screws | 50 | rpm |
| Starting temperature | 130° | C. |
| Mixing time | 40 | min |

The temperature profile in the course of the mixing process was as follows in Table 10:

TABLE 10
Temperature program of the two-step process in the Brabender kneader

| Period | Temperature (° C.) |
|---|---|
| Start of the mixing | 130 |
| First feed | 135 |
| Second feed | 140 |
| End of the mixing | 145 |

The appropriate amount of LDPE was fed into the chamber, and the polymer was melted. In the first step the mixture of Bentone-Perox TB-HEMA (first additive package) was added to the polymer. The first additive package was prepared by loading first the Bentone into a glass beaker, followed by the peroxide and finally by the liquid HEMA. The components were intensively homogenized by a glass rod, until a highly viscous paste was obtained. This paste was gradually added to the melted LDPE during a continuous mixing at 135° C. The grafting was performed in 10 min also during continuous mixing process. In the second step the mixture of Bentone-TDI (or MDI)-PHL-catalysts (second additive package) was added to the polymer. The second additive package was prepared similarly as the first one, that is, in another beaker glass first the Bentone was loaded, then the PHL, the catalysts (ZnSt, ChS944) and finally the liquid isocyanate component (TDI). The components were intensively homogenized by a glass rod until a paste was obtained, and then the paste was added to the above grafted LDPE, applying 10 min further homogenization in the Brabender mixer at 145° C. The formation of urethane linkages with the HEMA hydroxyl takes place already at this temperature, while the urethane formation of aromatic hydroxyl and isocyanate takes place only below 130° C.

### EXAMPLES 6-8

LDPE Based Compounds with Thermally Reversible Urethane Crosslinks. Crosslinking by Grafted Aliphatic Alcohol and Polyphenol-MDI Prepolymer

Compounds according to the invention were prepared by an identical two-step grafting/crosslinking procedure as described for examples 3-5, but, instead of TDI (toluylene 2,4-diisocyanate) MDI (methylene-diphenyl-diisocyanate, ONGRONAT HS-44, a commercial product of BorsodChem Rt., Hungary) was used as isocyanate component. The compositions are listed in Table 11.

TABLE 11
The composition of compounds (examples 6-8).

| | | Example 6 | | Example 7 | | Example 8 | |
|---|---|---|---|---|---|---|---|
| sample code | | 02-44 | | 02-45 | | 02-46 | |
| Component | ratio | mol | g | mol | g | mol | g |
| Tipolen FB 243-51 (matrix) | | | 230 | | 230 | | 230 |
| | First additive package | | | | | | |
| Perox-TB* | 0.5-1.5 phr | 0.0034 | 1.15 | 0.0068 | 2.3 | 0.0102 | 3.45 |
| 2-Hydroxy-ethyl-methacrylate | 2 mol HEMA/ | 0.0068 | 0.88 | 0.0136 | 1.77 | 0.0204 | 2.65 |
| (HEMA) | 1 mol Perox-TB | | | | | | |
| Bentone | 1 phr | | 2.3 | | 2.3 | | 2.3 |
| | Second additive package | | | | | | |
| Methylene-diphenyl- | 2 mol TDI/1 mol | 0.0068 | 1.70 | 0.0136 | 3.40 | 0.0204 | 5.10 |
| diisocyanate (MDI) | Perox-TB | | | | | | |
| Phloroglucinol (PHL) | 2 mol PHL/ | 0.0045 | 0.57 | 0.0091 | 1.14 | 0.0136 | 1.71 |
| | 3 mol MDI | | | | | | |
| Zinc-stearate (ZnSt) | 4% to MDI | | 0.10 | | 0.20 | | 0.31 |
| Chimasorb 944 (ChS944) | 4% to MDI | | 0.10 | | 0.20 | | 0.31 |
| Bentone | 1 phr | | 2.3 | | 2.3 | | 2.3 |

*Perox TB is given as active ingredient content (90% of the total weight)

### EXAMPLES 9-11

LDPE Based Compounds with Thermally Reversible Urethane Crosslinks. Crosslinking by Grafted Phenol and Grafted Isocyanate

Compounds according to the invention were prepared by a two-step grafting/crosslinking procedure, similar to those described for examples 3-5 processing parameters are identical with those described in Tables 9 and 10), but the materials and the additive packages were different. Materials used are described in Table 12, sample compositions in Table 13.

TABLE 12
Materials used in the synthesis of examples 9-11.

| | Role of | |
|---|---|---|
| Component | component | Characteristics |
| Tipolen FB 243-51 | Matrix | LDPE |
| (TVX Rt. Hungary) | | Mp. 111° C. |
| | | Density. 0.924 g/cm3 |
| | | MFI:: 0.8 (190° C./2.16 kg) |
| | | (g/10 min) |
| Luperox F90P (Perox TB: | Radical | See Table 5. |
| 1,3-1,4-bis(tert- | initiator | |
| butylperoxyisopropyl)- | Derivative | |
| benzene on silica powder) | of terc. Butyl | |
| (ATOFINA, France) | peroxide | |
| 2-Hydroxyethyl- | Aliphatic | See Table 5. |
| methacrylate (HEMA) | alcohol with | |
| | unsaturation | |
| 2-Allylphenol (APh) | Aromatic | Liquid, Mw: 134.18 g/mol |
| (Merck) | alcohol with | mp. −7-−5° C. |
| | unsaturation | bp. 219-221° C. |
| 2-Isocyanato-ethyl- | Aliphatic | Liquid, Mw: 155.16 g/mol |
| methacrylate (IEM) | isocyanate with | m.p. −45° C., |
| | unsaturation | bp. 211° C. |
| CHIMASORB 944 | Urethane | See Table 2. |
| (ChS944) | formation | |
| (CIBA-GEIGY) | catalyst | |
| Zinc-stearate | Urethane | See Table 2. |
| (ZnSt) | formation | |
| | catalyst | |
| Bentone SB | Dispersing | See Table 5. |
| (RHEOX Inc.) | agent | |

TABLE 13
The composition of compounds (examples 9-11).

| | | | | Example | | Example | |
|---|---|---|---|---|---|---|---|
| | | Example 9 | | 10 | | 11 | |
| sample code | | 02-50 | | 02-51 | | 02-52 | |
| Component | ratio | mol | g | mol | g | mol | g |
| Tipolen FB 243-51 | | | 230 | | 230 | | 230 |
| (matrix) | | | | | | | |
| | First additive package | | | | | | |
| Perox-TB* | 0.5-1.5 phr | 0.0017 | 0.58 | 0.0034 | 1.15 | 0.051 | 1.73 |
| 2-Allylphenol (APh) | 2 mol APh/ | 0.0034 | 0.46 | 0.0068 | 0.92 | 0.0102 | 1.37 |
| | 1 mol Perox-TB | | | | | | |
| Bentone | 1 phr | | 2.3 | | 2.3 | | 2.3 |
| | Second additive package | | | | | | |
| Perox-TB* | 0.5-1.5 phr | 0.0017 | 0.58 | 0.0034 | 1.15 | 0.051 | 1.73 |
| 2-Isocyanato-ethyl- | 2 mol IEM/1 mol | 0.0034 | 0.52 | 0.0068 | 1.04 | 0.0102 | 1.58 |
| methacrylate (IEM) | Perox-TB | | | | | | |
| Zinc-stearate (ZnSt) | 13% to IEM | | 0.07 | | 0.14 | | 0.21 |
| Chimasorb 944 (ChS944) | 13% to IEM | | 0.07 | | 0.14 | | 0.21 |
| Bentone | 1 phr | | 2.3 | | 2.3 | | 2.3 |

*Perox TB is given as active ingredient content (90% of the total weight)

The appropriate amount of LDPE was fed into the chamber, and the polymer was melted. In the first step the first additive package of Bentone-Perox TB-allylphenol (APh) was added to the polymer. The additive package was prepared by loading first the Bentone in a glass beaker, then the peroxide and finally the liquid APh. The components were intensively homogenized by a glass rod until a strong viscous paste was obtained. The paste was gradually added to the melted LDPE during continuous mixing at 135° C. Grafting reaction was finished in 10 min also during continuous mixing. In the second step the additive package of Bentone—isocyanato-ethyl-methacrylate (IEM)—catalysts was added to the polymer. This package was prepared similarly to the first one, that is, in another glass beaker first the Bentone was loaded, then Perox TB, the catalysts (ZnSt, ChS944) and finally the liquid isocyanate components (IEM). The components were intensively homogenized by a glass rod until the formation of a paste, and then the paste was added to the above grafted LDPE, applying 10 min further homogenisation in the Brabender mixer at 145° C.

Evaluation of the Compounds Prepared Under Examples 3-11

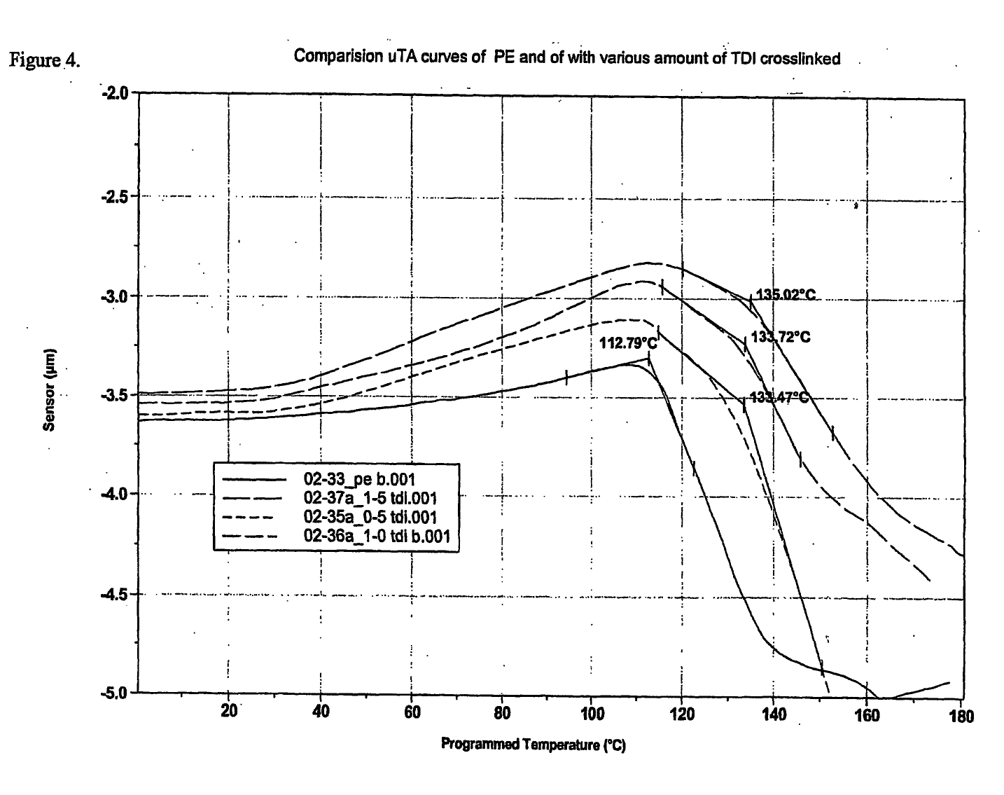

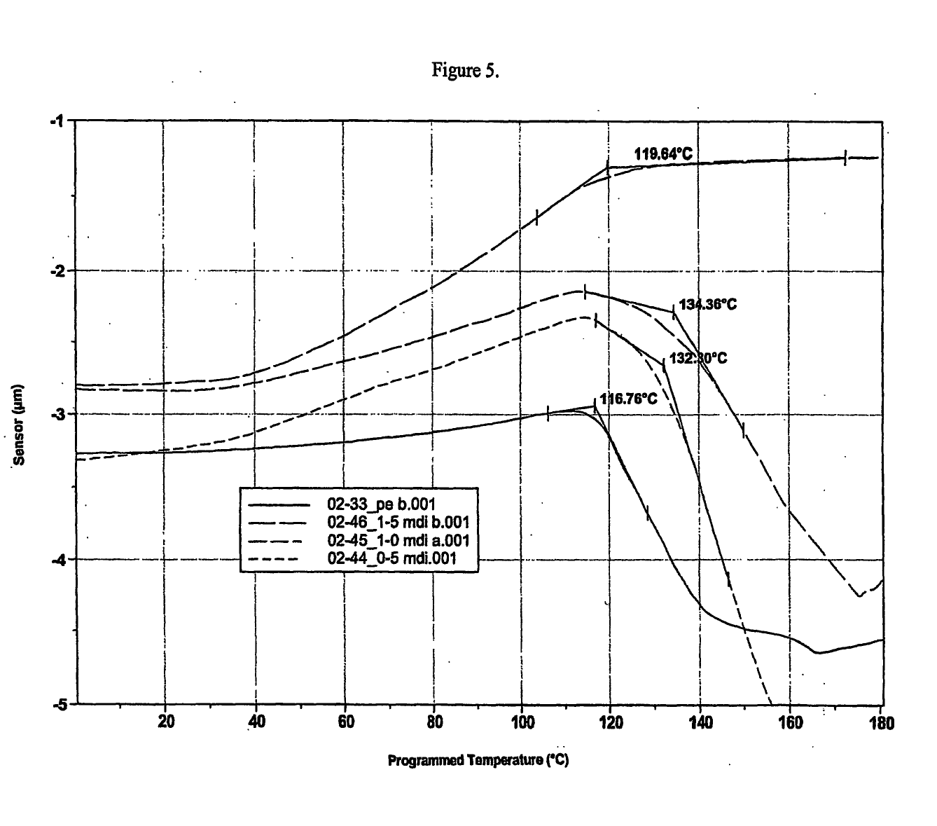

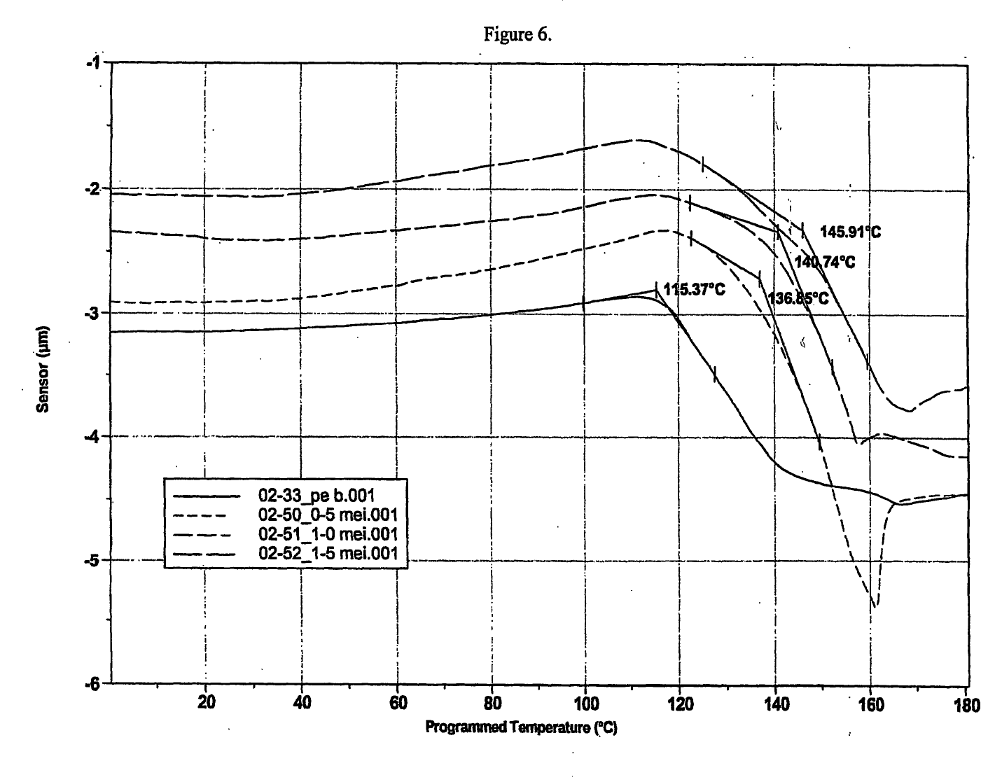

FIGS. 4, 5 and 6. show the micro-thermal analysis curves of the compounds prepared under examples 3-5,6-8 and 9-11 respectively. For comparison the μTA curve a non-crosslinked PE sample is also shown in each figure. Up to the melting point the thermal expansion is detected by a positive movement. In the melting-range (112-116° C. for the non-crosslinked samples) the sample softens and the probe penetrates the sample surface. The melting point can be estimated by the intersection of the slopes. In the case of the samples containing the reversible crosslinks the melting transition also appears as a change in the slope but, due to the presence of crosslinks the molten polymer does not flow, the elastomeric network still exerts some resistance to the penetration. When the urethane linkages begin to dissociate (in the 130-145° C. range) the slope increases further and the samples soften, similarly to the non-crosslinked samples. There is one exception: curve 02-46, corresponding to the sample prepared with 2 phr peroxide and MDI-based polyphenol—isocyanate prepolymer, where there is no softening upon further heating. It seems that in this case 2 phr peroxide already caused a true crosslinking of the LDPE sample, i.e. irreversible C—C crosslinks are also formed in addition to the thermally reversible urethane linkages. It also shows that the selection of proper additive packages is a delicate task. Anyway, all three types of compounds prepared with 1 phr peroxide and corresponding other additives seems to be acceptable.

The actual recyclability of three compounds prepared according to the invention (according to examples 4, 7 and 10, all with 1 phr peroxide and the corresponding additives) was checked by measuring the torque in a kneading chamber of the Brabender Plastograph at various temperatures (110 and 140° C.) and compared to non-crosslinked LDPE. The results are summarized in Table 14.

TABLE 14
Processing characteristics of PE and compounds prepared with various
crosslinking additives

| Cycle of | | | | | | | | Example | |
|---|---|---|---|---|---|---|---|---|---|
| processing | Characteristics | PE | | Example 4 | | Example 7 | | 10 | |
| Processing | | 110 | 140 | 110 | 135 | 110 | 140 | 110 | 140 |
| temperature, ° C. | | | | | | | | | |
| First cycle | Melting | Yes | Yes | No | Yes | No | Yes | No | Yes |
| | Start of melting, | 3 | 1.5 | — | 7 | — | 3.5 | — | 2.5 |
| | min | | | | | | | | |
| | Torque, Nm | 50* | 60** | — | 75 | . | 77 | — | 80 |
| Second | Melting | | | | | | | No | Yes |
| cycle | Start of melting, | | | | | | | — | 3 |
| | min | | | | | | | | |
| | Torque, Nm | | | | | | | — | 70 |

*PE compound prepared by use of 2 phr Bentone
**Virgin PE

As shown by the data, at 110° C. only the non-crosslinked sample can be melt-processed, the others, having thermally reversible crosslinks can only be processed at a higher temperature, exceeding the dissociation temperature of the urethane bond. The presence of crosslinks is also shown by the fact that the non-crosslinked LDPE sample melts at 140° C. within 1.5 min, while the crosslinked samples within 2.5-7 min. In the case of Example 10 a repeated processing cycle was also performed to prove the repeated processability of the polymer compound according to the invention.

1. A thermoplastic cross-linked polymer compound with thermally reversible urethane crosslinkages comprising the following essential components a) to d):
a) a thermoplastic polymer component with saturated molecular main chain;
b) a component containing isocyanate group(s), either attached to the polymer chain or being present in mobile form in the polymer matrix;
c) a component containing hydroxyl group(s) either attached to the polymer chain or being present in mobile form in the polymer matrix;
d) a catalyst package promoting the reversible formation and thermal dissociation of urethane bonds,
characterized in that at least one of the components b) and c) is attached to the polymer chain and at least one of the additives present in the compound is multi-functional, playing a role in more than one, functionally independent processes.

2. The compound according to claim 1 wherein the component b) containing the isocyanate group(s) is attached to the polymer chain by copolymerisation, grafting or by polymer-analog reaction.

3. The compound according to any of claims 1 and 2 wherein the component c) contains phenolic, aliphatic or cycloaliphatic hydroxyl groups.

4. The compound according to claim 3 wherein the component c) contains phenolic hydroxyl groups.

5. The compound according to any of claims 1 to 4 wherein the component c) containing the hydroxyl group(s) is attached to the polymer chain by copolymerisation, grafting or by polymer-analog reaction.

6. The compound according to claim 1 wherein when the isocyanate group is attached to the main chain, the hydroxyl component exhibits an average functionality of at least 2.

7. The compound according to claims 1 or 6 wherein when the hydroxyl component is attached to the main chain, the isocyanate component exhibits an average functionality of at least 2.

8. The compound according to any of claims 6 and 7 wherein when both components are attached to the main chain, the functionalized polymer molecules themselves exhibit an average functionality of at least 2.

9. The compound according to any of claims 1 to 8 wherein the thermoplastic polymer is a polyolefin.

10. The compound according to claim 9 wherein the isocyanate and/or the hydroxyl groups are attached to the main chain by radical grafting reaction so that essentially no irreversible C—C crosslink points are formed, or at least their presence does not cause gelation after the thermal dissociation of the thermally reversible urethane crosslink points.

11. The compound according to any of claims 9 and 10 wherein the isocyanate component is chemically attached to the main chain of the thermoplastic component and the hydroxyl group is present in a low molecular mobile polyphenol or in a prepolymer/oligomer.

12. The compound according to any of claims 9 and 10 wherein the hydroxyl group is attached to the main chain of the thermoplastic component and the isocyanate component is present in a low molecular mobile polyisocyanate or in a prepolymer/oligomer.

13. The compound according to any of claims 9 and 10 wherein both the isocyanate and the hydroxyl groups are chemically attached to the main chain of the thermoplastic component.

14. The compound according to claim 9 wherein the hydroxyl group is present in a polyphenol, which simultaneously acts as an antioxidant and/or thermal stabilizer, optionally grafted to the polymer main chain.

15. The compound according to claim 9 wherein the thermoplastic polymer is ethylene, propylene or other α-olefin homo- or copolymer, or a blend of such homo- or copolymers.

16. The compound according to any of claims 1 to 15 wherein the catalyst package consists of a non-volatile (T_{b}>150° C.) tertiary amine and a transition metal salt of a linear or branched chain mono- or polybasic carboxylic acid with at least 10 carbon atoms.

17. The compound according to claim 16 wherein the metal salt is zinc stearate.

18. The compound according to claim 16 wherein the non-volatile amine compound is a hindered amine light stabilizer.

19. The compound according to any of claims 1 to 8 further containing a processing aid consisting of a layered silicate or a mixture of layered silicates, promoting the uniform distribution of the additives in the polymer matrix and preventing their macroscopic phase separation.

20. The compound according to claim 19 wherein the layered silicates are selected from consisting of organophilic montmorillonite, bentonite, fluoro-hectorite, clay, talc or mica.

21. A process for preparing a thermoplastic compound according to any of claims 19 to 20 consisting of the following steps:
a) preparing a first additive package containing the monomer(s) of one of the components b) and c) to be grafted and the radical source and a processing aid, by mixing the processing aid first with the radical source, then with other component(s)
b) preparing a second additive package containing the other urethane forming component not present in the first additive package, the processing aid, the urethane catalysts and, if both the hydroxyl and the isocyanate components are to be grafted, the radical source, such as peroxide, by mixing first the processing aid with the solid components, then with other component(s),
c) melting the thermoplastic polymer,
d) mixing the first additive package with the molten polymer at a temperature where the grafting reaction is complete within a few minutes,
e) mixing the second additive package with the molten polymer obtained in step d) at a temperature where the urethane formation reaction is complete within a few minutes,
f) followed by proper shaping (e.g. extrusion/granulation, injection, etc.) the compound and cooling down.

22. The process according to claim 21 wherein in steps a) and/or b) at least one organic solvent is used to combine the processing aid and the additives if all components are solid initially.

23. A continuous process according to any of claims 21 and 22 wherein the mixing process is performed in a multi-port extruder and the additive packages are added to the system at subsequent feed-ports.

24. Plastic semi-finished goods and products made of thermoplastic compounds according to any of claims 1 to 20.

25. Plastic semi-finished goods and products made of thermoplastic compounds prepared by the methods according to any of claims 21 to 23.
